(19) United States
(12) Patent Application Publication
(10) Pub. No.: US 2023/0023960 A1
(43) Pub. Date: Jan. 26, 2023

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Yu NAGATA, Tokyo (JP); Toshihiro Nakamura, Suntou-gun (JP)

(73) Assignee: TOYOTA JIDOSHA KABUSHIKI KAISHA, Toyota-shi (JP)

(21) Appl. No.: 17/825,353

(22) Filed: May 26, 2022

(30) Foreign Application Priority Data
Jul. 21, 2021 (JP) 2021-120212

(51) Int. Cl. B60W 30/182; G06Q 30/02

(52) U.S. Cl. CPC B60W 30/182; G06Q 30/0283; B60W 2510/244; B60W 2530/209

(57) ABSTRACT

Either a mode in which a vehicle travels with an electric motor or a mode in which the vehicle travels with an internal combustion engine is selected based on information on a fee when the vehicle is caused to travel with the electric motor and information on a fee when the vehicle is caused to travel with the internal combustion engine.

### CROSS-REFERENCE TO RELATED APPLICATION

This application claims priority to Japanese Patent Application No. 2021-120212 filed on Jul. 21, 2021, incorporated herein by reference in its entirety.

### BACKGROUND

### 1. Technical Field

The present disclosure relates to an information processing device and an information processing method.

### 2. Description of Related Art

There is known a technique for acquiring schedule information of a plurality of users and attribute information indicating a mutual relationship of at least a part of the users among the plurality of users, and determining an operation schedule of an autonomous driving vehicle based on the above information (see, for example, WO 2018/230646).

### SUMMARY

An object of the present disclosure is to more appropriately perform switching of the traveling mode.

An aspect of the present disclosure is an information processing device including a control unit that executes selection of either a mode in which a vehicle travels with an electric motor or a mode in which the vehicle travels with an internal combustion engine, based on information on a fee when the vehicle is caused to travel with the electric motor and information on a fee when the vehicle is caused to travel with the internal combustion engine.

An aspect of the present disclosure is an information processing method in which a computer executes selection of either a mode in which a vehicle travels with an electric motor or a mode in which the vehicle travels with an internal combustion engine, based on information on a fee when the vehicle is caused to travel with the electric motor and information on a fee when the vehicle is caused to travel with the internal combustion engine.

Another aspect of the present disclosure is a program for causing a computer to execute a process in the above information processing device, or a storage medium that non-temporarily stores the program.

According to the present disclosure, switching of the traveling mode can be performed more appropriately.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system according to an embodiment;

FIG. 2 is a diagram showing a functional configuration of a server;

FIG. 3 is a diagram showing an example of a table configuration of fee information stored in a fee information database (DB);

FIG. 4 is a diagram showing a functional configuration of an electronic control unit (ECU);

FIG. 5 is a diagram for describing comparison of costs;

FIG. 6 is a flowchart of a traveling mode selection process according to a first embodiment;

FIG. 7 is a diagram showing an example of a functional configuration of a server according to a second embodiment;

FIG. 8 is a diagram showing an example of a table configuration of information on a carbon dioxide (CO₂) emission amount stored in a CO₂ emission amount information DB; and

FIG. 9 is a flowchart of a traveling mode selection process according to the second embodiment.

### DETAILED DESCRIPTION OF EMBODIMENTS

An information processing device that is one of the modes of the present disclosure includes a control unit. Based on information on the fee when the vehicle is caused to travel with an electric motor and information on the fee when the vehicle is caused to travel with an internal combustion engine, the control unit executes selection of either the mode in which the vehicle travels with the electric motor or the mode in which the vehicle travels with the internal combustion engine.

The vehicle is, for example, a hybrid electric vehicle having an electric motor and an internal combustion engine as a drive source. The vehicle may move autonomously or may be moved by being driven by a driver. The mode in which the vehicle travels with the electric motor is a mode in which the vehicle is caused to travel mainly by the driving force of the electric motor. The mode in which the vehicle travels with the internal combustion engine is a mode in which the vehicle is caused to travel mainly by the driving force of the internal combustion engine. Even in the mode in which the vehicle travels with the internal combustion engine, the driving force of the electric motor may be used as an auxiliary. Further, even in the mode in which the vehicle travels with the electric motor, the driving force of the internal combustion engine may be used as an auxiliary, or the internal combustion engine may be used to generate electric power.

The information on the fee may be, for example, information on the fee paid by the user to cause the vehicle to travel. For example, the control unit may select a traveling mode in which the user pays less fee to cause the vehicle to travel.

Here, the fee according to the fuel amount of the internal combustion engine and the fee according to the electric energy when charging the battery for supplying electric power to the electric motor differ, for example, depending on the region and time. Thus, for example, even if the vehicle 10 is caused to travel in the same traveling mode, the fee paid by the user for causing the vehicle to travel differs depending on the region and time.

Therefore, the fee paid by the user can be reduced by selecting the traveling mode in which the fee paid by the user is the lowest.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

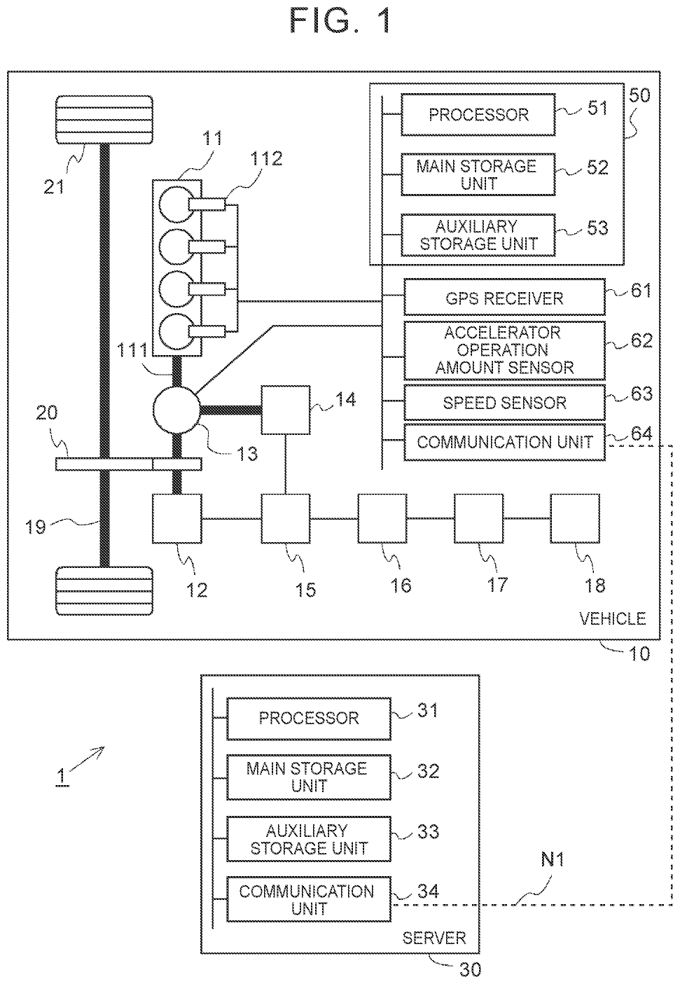

FIG. 1 is a diagram showing a schematic configuration of a system 1 according to the present embodiment. The system 1 includes a vehicle 10 and a server 30. The system 1 is a system that selects a traveling mode of the vehicle 10 so that the fee paid by the user is lower, that is, the cost is lower. The vehicle 10 may be a vehicle capable of autonomous traveling or a vehicle capable of traveling manually by a driver. The vehicle 10 is a so-called plug-in hybrid electric vehicle.

The vehicle 10 and the server 30 are connected to each other by a network N1. The network N1 is, for example, a world-wide public communication network such as the Internet, and a wide area network (WAN) or other communication networks may be adopted. In addition, the network N1 may include a telephone communication network such as a mobile phone network or a wireless communication network such as Wi-Fi (registered trademark).

The vehicle 10 transmits traveling data of the vehicle 10, such as the current position of the vehicle 10, to the server 30 at a predetermined timing. The server 30 accumulates the traveling data received from the vehicle 10 and performs various calculations and the like based on the accumulated traveling data. Then, the server 30 transmits the information obtained from the calculation result to the vehicle 10. Hereinafter, a detailed hardware configuration of the vehicle 10 and the server 30 will be described with reference to FIG. 1.

The vehicle 10 includes an internal combustion engine 11, an electric motor 12, a power split mechanism 13, a generator 14, an inverter 15, a battery 16, a charge control circuit 17, a power inlet 18, an axle 19, a speed reducer 20, wheels 21, and an electronic control unit (ECU) 50. In addition to these, the vehicle 10 includes a global positioning system (GPS) receiver 61, an accelerator operation amount sensor 62, a speed sensor 63, and a communication unit 64.

The internal combustion engine 11 combusts fuel in cylinders to generate power for rotating an output shaft 111 connected to a crankshaft. Each cylinder of the internal combustion engine 11 is provided with a fuel injection valve 112. The fuel injection valve 112 may inject fuel directly into the cylinder or may inject fuel into the intake port. The fuel injection valve 112 is connected to the ECU 50 via an electric wire, and opening/closing timing of the fuel injection valve 112 is controlled by the ECU 50.

The power split mechanism 13 distributes the output from the internal combustion engine 11 to the generator 14 and the axle 19. The power split mechanism 13 also has a function of transmitting the output from the electric motor 12 to the axle 19. The power split mechanism 13 includes, for example, a sun gear, a ring gear, a pinion gear, and a planetary carrier.

The electric motor 12 is, for example, a three-phase alternating-current (AC) synchronous motor generator. The electric motor 12 has a function as an electric motor that is driven by power running by receiving electric power supplied from the battery 16. The electric motor 12 rotates at a rotation speed proportional to the axle 19 via the speed reducer 20. The electric motor 12 can also assist the output of the internal combustion engine 11 if necessary.

The battery 16 is connected to the electric motor 12 and the generator 14 via the inverter 15. The battery 16 is a secondary battery that can be charged and discharged, such as a nickel-cadmium storage battery, a nickel-hydrogen storage battery, or a lithium ion battery. The battery 16 is electrically connected to the electric motor 12 and the generator 14 via the inverter 15 or the like such that the charging power of the battery 16 is supplied to the electric motor 12 to be able to drive the electric motor 12 for power running and the generated power of the generator 14 can be charged to the battery 16.

The battery 16 according to the present embodiment is configured to be electrically connectable to an external power supply via the charge control circuit 17 and the power inlet 18 so that the battery 16 can be charged from the external power supply such as a household outlet. That is, the vehicle 10 according to the present embodiment is a so-called plug-in hybrid electric vehicle. The charge control circuit 17 is an electric circuit that can, based on a control signal from the ECU 50, convert the alternating current supplied from the external power supply into a direct current, boost the input voltage to the battery voltage, and charge the battery 16 with the electric power of the external power supply. The inverter 15 converts a direct current and an alternating current, and adjusts the current or voltage.

The GPS receiver 61 receives signals from three or more GPS satellites, identifies the latitude and longitude of the vehicle 10, and detects the current position of the vehicle 10. The GPS receiver 61 transmits the detected current position information of the vehicle 10 to the ECU 50.

The accelerator operation amount sensor 62 is a sensor that detects the amount of depression of the accelerator pedal by the driver of the vehicle 10. The detection value of the accelerator operation amount sensor 62 correlates with the load of the vehicle 10. The speed sensor 63 is a sensor that detects the speed of the vehicle 10. The detection value of the accelerator operation amount sensor 62 and the detection value of the speed sensor 63 are transmitted to the ECU 50.

The communication unit 64 is means for communicating with the server 30 via the network N1. The communication unit 64 is, for example, a local area network (LAN) interface board or a wireless communication circuit for wireless communication. The LAN interface board and the wireless communication circuit are connected to the network N1.

The ECU 50 has a computer configuration. The ECU 50 includes a processor 51, a main storage unit 52, and an auxiliary storage unit 53. The components are connected to each other by a bus. The processor 51 is an example of a control unit. The main storage unit 52 and the auxiliary storage unit 53 are examples of storage units.

The processor 51 is a central processing unit (CPU), a digital signal processor (DSP), or the like. The processor 51 controls the vehicle 10 and performs various information processing calculations. The main storage unit 52 is a random access memory (RAM), a read-only memory (ROM), or the like. The auxiliary storage unit 53 is an erasable programmable ROM (EPROM), a hard disk drive (HDD), a removable medium, or the like. The auxiliary storage unit 53 stores an operating system (OS), various kinds of programs, various kinds of tables, and the like. The processor 51 loads the program stored in the auxiliary storage unit 53 into the work area of the main storage unit 52 and executes the program. Through execution of the program, each component is controlled. As a result, the ECU 50 realizes the function that matches the predetermined purpose. The main storage unit 52 and the auxiliary storage unit 53 are computer-readable recording media. The information stored in the auxiliary storage unit 53 may be stored in the main storage unit 52. Further, the information stored in the main storage unit 52 may be stored in the auxiliary storage unit 53.

The ECU 50 drives each control component to control the vehicle 10 based on an output signal and the like input from various sensors.

The server 30 has a computer configuration. The server 30 includes a processor 31, a main storage unit 32, an auxiliary storage unit 33, and a communication unit 34. The components are connected to each other by a bus. The processor 31, the main storage unit 32, and the auxiliary storage unit 33 are similar to the processor 51, the main storage unit 52, and the auxiliary storage unit 53 of the vehicle 10, respectively, and thus the description thereof will be omitted.

The communication unit 34 is means for communicating with the vehicle 10 and an external server via the network N1. The communication unit 34 is, for example, a LAN interface board or a wireless communication circuit for wireless communication. The LAN interface board and the wireless communication circuit are connected to the network N1.

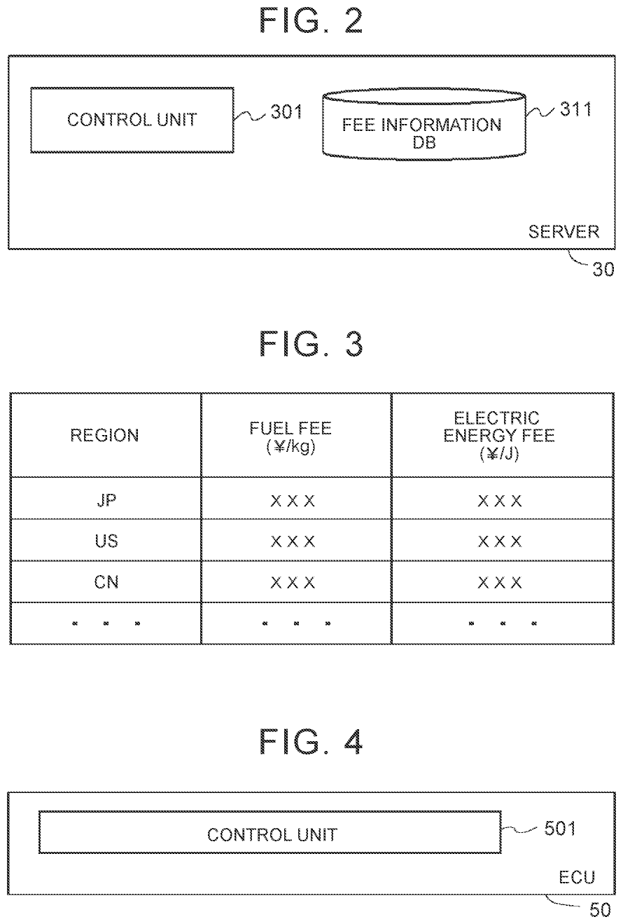

Next, the function of the server 30 will be described. FIG. 2 is a diagram showing an example of a functional configuration of the server 30. The server 30 includes a control unit 301 and a fee information database (DB) 311 as functional components. The processor 31 of the server 30 executes the process of the control unit 301 using a computer program stored in the main storage unit 32. Note that a part of the process of the control unit 301 may be executed by another computer connected to the network N1.

The fee information DB 311 is constructed in a manner such that a program of a database management system (DBMS) executed by the processor 31 manages data stored in the auxiliary storage unit 33. The fee information DB 311 is, for example, a relational database.

FIG. 3 is a diagram showing an example of a table configuration of the fee information stored in the fee information DB 311. The fee information DB 311 is a database used by the control unit 301 to provide the vehicle 10 with information on the fuel fee and information on the electric energy fee. The table of the fee information includes fields for the region, the fuel fee, and the electric energy fee. Information on a country is, for example, input in the region field. This is because the fuel fee and the electric energy fee are considered to differ from country to country. An administrative division smaller than a country may be input in the region field. Further, the region is not limited to the administrative division, and for example, a mesh code or the like may be input. Information on the fuel fee of the internal combustion engine 11 is input in the fuel fee field. As the information on the fuel fee, for example, information on the fee per 1 kg of the fuel (yen/kg) is input. Information on the fee corresponding to the electric energy for charging the battery 16 is input in the electric energy fee field. As the information on the electric energy fee, for example, information on the fee per 1 J of the electric energy (yen/J) is input. The fuel fee and the electric energy fee are the prices paid by the user, and are, for example, the price when purchasing fuel at a gas station, or the price when the user charges the battery 16 at a house or the like. Fuel fees may vary depending on the gas station. Therefore, the average value or the standard value in the region may be considered as the price to be paid by the user.

In response to a request from the vehicle 10, the control unit 301 provides information on the fee corresponding to the fuel of the internal combustion engine 11 and information on the fee corresponding to the electric energy for charging the battery 16. The control unit 301 acquires the region where the vehicle 10 is located based on the position information received from the vehicle 10. The fuel fee and the electric energy fee corresponding to the region are acquired based on the fee information DB 311 and transmitted to the vehicle 10. Although one server 30 is shown in FIG. 1, as an alternative method, the server that provides the fee corresponding to the fuel and the server that provides the fee corresponding to the electric energy may be different.

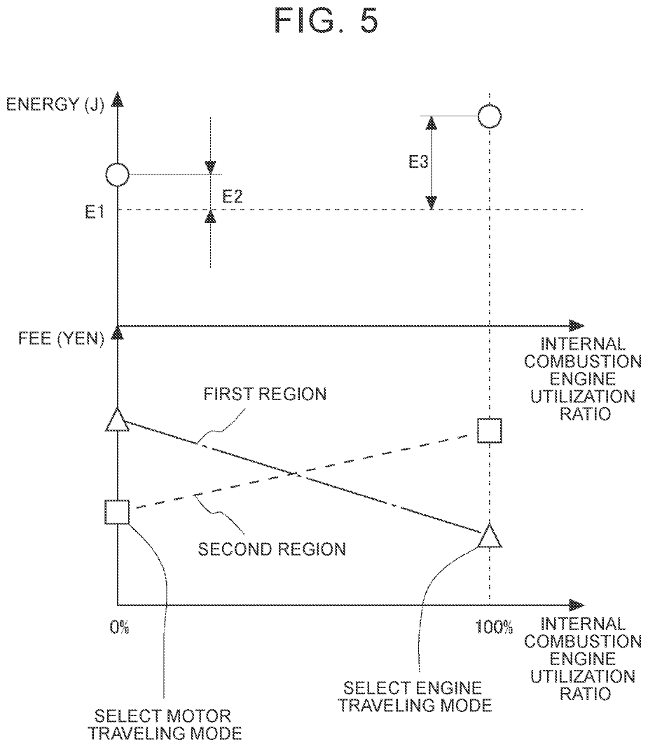

Next, the function of the ECU 50 of the vehicle 10 will be described. FIG. 4 is a diagram showing a functional configuration of the ECU 50. The ECU 50 includes a control unit 501 as a functional component. The processor 51 of the ECU 50 executes the process of the control unit 501 using a computer program stored in the main storage unit 52. However, any of the functional components or part of the processes thereof may be executed by a hardware circuit. Note that any of the functional components of the ECU 50 or part of the processes thereof may be executed by another computer connected to the network N1.

First, the contents of the basic traveling control of the vehicle 10 performed by the control unit 501 will be described. The control unit 501 selects either the motor traveling mode or the engine traveling mode as the traveling mode, and causes the vehicle 10 to travel. The motor traveling mode is a mode in which the electric motor 12 is driven by power running using the charging power of the battery 16 and the power of the electric motor 12 is transmitted to the axle 19 to cause the vehicle 10 to travel. When the motor traveling mode is selected, the internal combustion engine 11 is stopped.

The engine traveling mode is a mode in which the internal combustion engine 11 is operated by using fuel and the power of the internal combustion engine 11 is transmitted to the axle 19 to cause the vehicle 10 to travel. When the engine traveling mode is selected, the electric motor 12 is stopped. Although the motor traveling mode is a mode in which the electric motor 12 is used as the drive source of the vehicle 10, the internal combustion engine 11 may be operated as an auxiliary. Similarly, although the engine traveling mode is a mode in which the internal combustion engine 11 is used as the drive source of the vehicle 10, the electric motor 12 may be operated as an auxiliary. For example, even in the motor traveling mode, when the amount of electric power stored in the battery 16 becomes equal to or less than the threshold value and charging is required, the internal combustion engine 11 may be operated to charge the battery 16.

When the traveling mode is the motor traveling mode, for example, the control unit 501 controls the output of the electric motor 12 to cause the vehicle 10 to travel based on the traveling load so that the required output according to the traveling load is achieved, with the internal combustion engine 11 stopped. On the other hand, when the traveling mode is the engine traveling mode, for example, the control unit 501 controls the output of the internal combustion engine 11 to cause the vehicle 10 to travel based on the traveling load so that the required output according to the traveling load is achieved, in a state where the supply of electric power to the electric motor 12 is stopped.

The control unit 501 compares the fee required when traveling in the motor traveling mode and the fee required when traveling in the engine traveling mode, and switches to a traveling mode with a lower fee. Here, FIG. 5 is a diagram for describing comparison of costs. FIG. 5 shows a relationship between an energy (J) and a fee (yen) with respect to the utilization ratio (%) of the internal combustion engine 11. When the utilization ratio in the horizontal axis is 0%, the utilization ratio of the internal combustion engine 11 is 0%, and the vehicle travels without using the internal combustion engine 11, that is, the motor traveling mode is selected. When the utilization ratio in the horizontal axis is 100%, the utilization ratio of the internal combustion engine 11 is 100%, and the vehicle travels using only the internal combustion engine 11, that is, the vehicle travels in the engine traveling mode. FIG. 5 shows a case in which the vehicle 10 is constantly traveling at, for example, 30 km/h.

E1 in FIG. 5 shows the energy that is at least required for the vehicle 10 to travel. E2 shows the energy corresponding to the decrease in efficiency when traveling in the motor traveling mode. E2 is a decrease in the energy associated with the efficiency of the battery 16 and the efficiency of the vehicle 10. E3 shows the energy corresponding to the decrease in efficiency when traveling in the engine traveling mode. E3 is a decrease in the energy associated with the efficiency of the internal combustion engine 11 and the efficiency of the vehicle 10.

Depending on the traveling condition and the vehicle 10, the minimum energy required for traveling and the energy corresponding to the decrease in efficiency when traveling in each traveling mode vary. For example, the auxiliary storage unit 53 of the ECU 50 stores the relationship between the traveling condition and the minimum energy required for traveling, and the relationship between the traveling condition and the energy corresponding to the decrease in efficiency when traveling in each traveling mode.

In the example shown in FIG. 5, in the motor traveling mode (that is, when the internal combustion engine utilization ratio is 0%), the sum of E1 and E2 (E1+E2) corresponds to the energy consumed when the vehicle 10 travels. On the other hand, in the engine traveling mode (that is, when the internal combustion engine utilization ratio is 100%), the sum of E1 and E3 (E1+E3) corresponds to the energy consumed when the vehicle 10 travels.

Next, based on the energy consumed when the vehicle 10 travels in the motor traveling mode and the energy consumed when the vehicle 10 travels in the engine traveling mode, the fee required when the vehicle 10 travels in each traveling mode is calculated. In FIG. 5, as an example, the fee required when the vehicle 10 travels in each traveling mode is calculated for each of a first region and a second region. For example, the fee (yen) when the vehicle 10 travels in the motor traveling mode can be calculated by multiplying the consumption energy (J) by the electric energy fee (yen/J). On the other hand, for example, the fee (yen) when the vehicle 10 travels in the engine traveling mode can be calculated by multiplying a value obtained by dividing the consumption energy (J) by the heat generation amount of the fuel (J/kg) by the fuel fee (yen/kg).

The information on the electric energy fee and the information on the fuel fee are acquired from the server 30 and stored in the auxiliary storage unit 53. The information on the electric energy fee and the information on the fuel fee are, for example, acquired from the server 30 by the control unit 501 and updated at predetermined time intervals.

In the first region shown in FIG. 5, the fee is higher in the motor traveling mode than in the engine traveling mode. Therefore, the control unit 501 selects the engine traveling mode when the vehicle 10 is constantly traveling at 30 km/h in the first region. However, in the second region shown in FIG. 5, the fee is lower in the motor traveling mode than in the engine traveling mode. Therefore, the control unit 501 selects the motor traveling mode when the vehicle 10 is constantly traveling at 30 km/h in the second region.

Depending on the amount of electric power stored in the battery 16, the vehicle 10 may not be able to travel in the motor traveling mode. In that case, for example, the vehicle 10 may be caused to travel by using both the internal combustion engine 11 and the electric motor 12 with the engine utilization ratio set to 20%. Further, in the engine traveling mode, the battery 16 may be charged by generating an output higher than the output required for causing the vehicle 10 to travel.

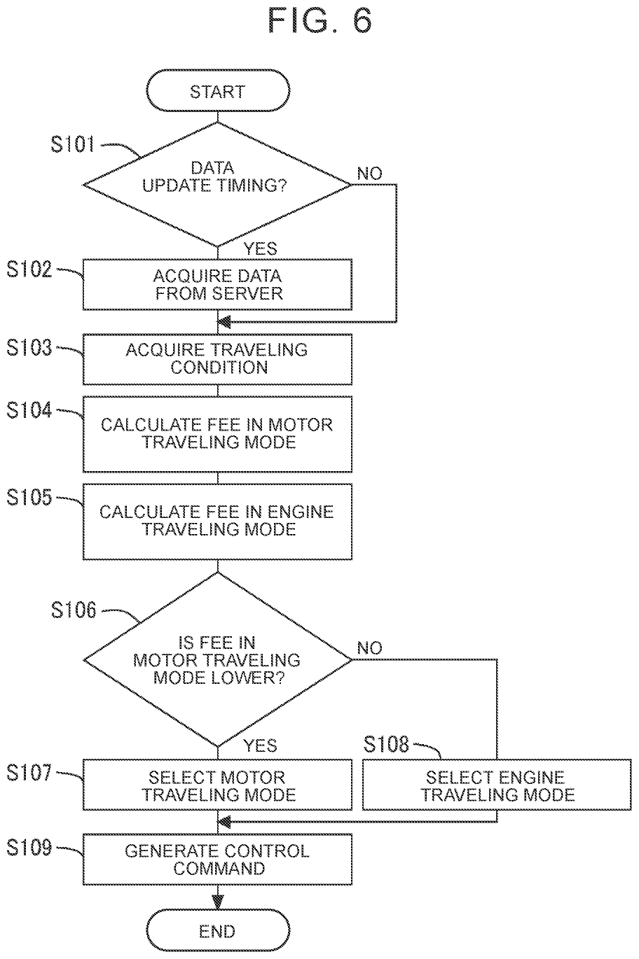

Next, the traveling mode selection process in the vehicle 10 will be described. FIG. 6 is a flowchart of a traveling mode selection process according to the present embodiment. The traveling mode selection process shown in FIG. 6 is executed in the vehicle 10 at predetermined time intervals.

In step S101, the control unit 501 determines whether the data update timing has come. This data is data for calculating the fee when traveling in each traveling mode. This data is updated periodically. When the determination result is Yes in step S101, the process proceeds to step S102, and when the determination result is No, the process proceeds to step S103.

In step S102, the control unit 501 acquires data from the server 30. The control unit 501 accesses the server 30 and acquires data for calculating the fee when traveling in each traveling mode. At this time, the control unit 501 transmits the position information detected by the GPS receiver 61 to the server 30, and acquires the data according to the region from the server 30. That is, the control unit 301 of the server 30 acquires the information on the fee from the fee information DB 311 according to the position information received from the vehicle 10, and transmits the information to the vehicle 10.

In step S103, the control unit 501 acquires the traveling condition of the vehicle 10. The control unit 501 acquires the detection value of the accelerator operation amount sensor 62 and the detection value of the speed sensor 63 as physical quantities that correlate with the traveling condition of the vehicle 10.

In step S104, the control unit 501 calculates the fee required when it is assumed that the vehicle travels in the motor traveling mode under the traveling condition acquired in step S103. The fee in this case is calculated by the following formula. Fee (yen)=consumption energy (J)×electric energy fee (yen/J)

The consumption energy in this case corresponds to the above E1+E2. For the consumption energy and the electric energy fee, the values received from the server 30 and stored in the auxiliary storage unit 53 are used.

In step S105, the control unit 501 calculates the fee required when it is assumed that the vehicle travels in the engine traveling mode under the traveling condition acquired in step S103. The fee in this case is calculated by the following formula. Fee (yen)=consumption energy (J)±heat generation amount of fuel (J/kg)×fuel fee (yen/J) The consumption energy in this case corresponds to the above E1+E3. For the consumption energy, the heat generation amount of fuel, and the fuel fee, the values received from the server 30 and stored in the auxiliary storage unit 53 are used.

In step S106, the control unit 501 determines whether the fee in the motor traveling mode calculated in step S104 is lower than the fee in the engine traveling mode calculated in step S105. When the determination result is Yes in step S106, the process proceeds to step S107, and when the determination result is No, the process proceeds to step S108.

In step S107, the control unit 501 selects the motor traveling mode. On the other hand, in step S108, the control unit 501 selects the engine traveling mode. Then, in step S109, the control unit 501 generates a control command according to the selected traveling mode. The control command includes, for example, a command to switch to the selected traveling mode.

As described above, according to the present embodiment, a traveling mode in which the fee is lower is selected according to the traveling condition of the vehicle 10. Therefore, the cost when the vehicle 10 travels can be further reduced.

### Second Embodiment

In the first embodiment, the traveling mode is selected based on the fee paid by the user. However, the environmental load may increase depending on the selected traveling mode. For example, depending on the selected traveling mode, the CO₂ emission amount may increase. Therefore, in the second embodiment, the traveling mode is selected further considering the environmental load. Since the hardware configurations of the vehicle 10 and the server 30 are the same as those in the first embodiment, the description thereof will be omitted.

In recent years, there has been a demand for reduction of the CO₂ emission amount from the viewpoint of carbon neutrality. Here, the CO₂ is emitted not only when the vehicle 10 travels, but also, for example, during transportation for transporting fuel to a gas station. Further, even when the vehicle travels with the electric motor 12, CO₂ may be emitted in order to generate the required electric power. Therefore, it is desired to reduce the CO₂ emission amount on a well-to-wheel basis (from an oil field to driving a tire, hereinafter also referred to as “WtW”).

For example, when the battery 16 is charged with the electric power generated in a thermal power plant, the CO₂ emission amount on the WtW basis is relatively high. On the other hand, when the battery 16 is charged with the electric power generated by using renewable energy such as solar power generation or wind power generation, the CO₂ emission amount on the WtW basis is relatively low. For example, in a region where all the electric power is generated by the renewable energy, the CO₂ emission amount on the WtW basis when the vehicle 10 travels in the motor traveling mode can be zero. The lower the ratio of the electric power generated by the renewable energy, the higher the CO₂ emission amount on the WtW basis. Therefore, in the future, as the ratio of the amount of electric power generated by the renewable energy increases, the CO₂ emission amount on the WtW basis when the vehicle travels in the motor traveling mode decreases. As described above, the CO₂ emission amount on the WtW basis may change depending on the region where the vehicle 10 travels or time when the vehicle 10 travels.

Therefore, the control unit 501 calculates the CO₂ emission amount on the WtW basis when traveling in each traveling mode, and selects the traveling mode in consideration of the CO₂ emission amount on the WtW basis. Since the CO₂ emission amount on the WtW basis when the vehicle travels in each traveling mode correlates with the energy consumed by the vehicle 10, the CO₂ emission amount is calculated based on this energy. As described in the first embodiment, the energy consumption according to the traveling condition is acquired from the server 30. The CO₂ emission amount on the WtW basis with respect to the energy consumption in each traveling mode is also acquired from the server 30. The control unit 501 corrects the fee by, for example, multiplying the fee when traveling in the engine traveling mode by a coefficient corresponding to the CO₂ emission amount when traveling in the engine traveling mode. Similarly, the control unit 501 corrects the fee by, for example, multiplying the fee when traveling in the motor traveling mode by a coefficient corresponding to the CO₂ emission amount when traveling in the motor traveling mode. Then, the corrected fee when traveling in the engine traveling mode is compared with the corrected fee when traveling in the motor traveling mode, and the traveling mode with the lower fee is selected. The coefficient may be the CO₂ emission amount itself or a value adjusted depending on how much the CO₂ emission amount is considered. For example, the coefficient may be adjusted so that the coefficient is larger in a region where reduction of the CO₂ emission amount is desired.

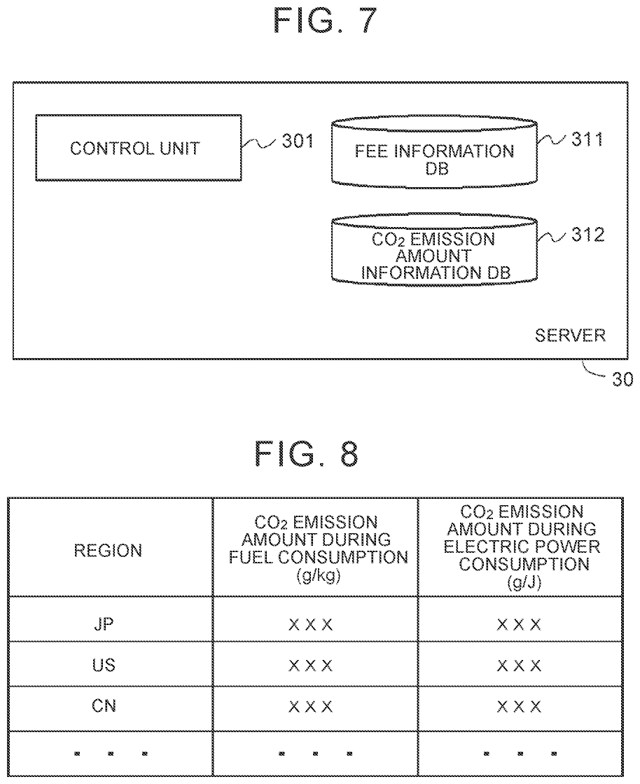

Next, the function of the server 30 according to the second embodiment will be described. FIG. 7 is a diagram showing an example of a functional configuration of the server 30. The server 30 includes the control unit 301, the fee information database DB 311, and a CO₂ emission amount information DB 312 as functional components. Since the fee information DB 311 is the same as that in the first embodiment, the description thereof will be omitted. The processor 31 of the server 30 executes the process of the control unit 301 using a computer program stored in the main storage unit 32. Note that a part of the process of the control unit 301 may be executed by another computer connected to the network N1.

The CO₂ emission amount information DB 312 is constructed in such a manner that a program of a DBMS executed by the processor 31 manages data stored in the auxiliary storage unit 33. The CO₂ emission amount information DB 312 is, for example, a relational database.

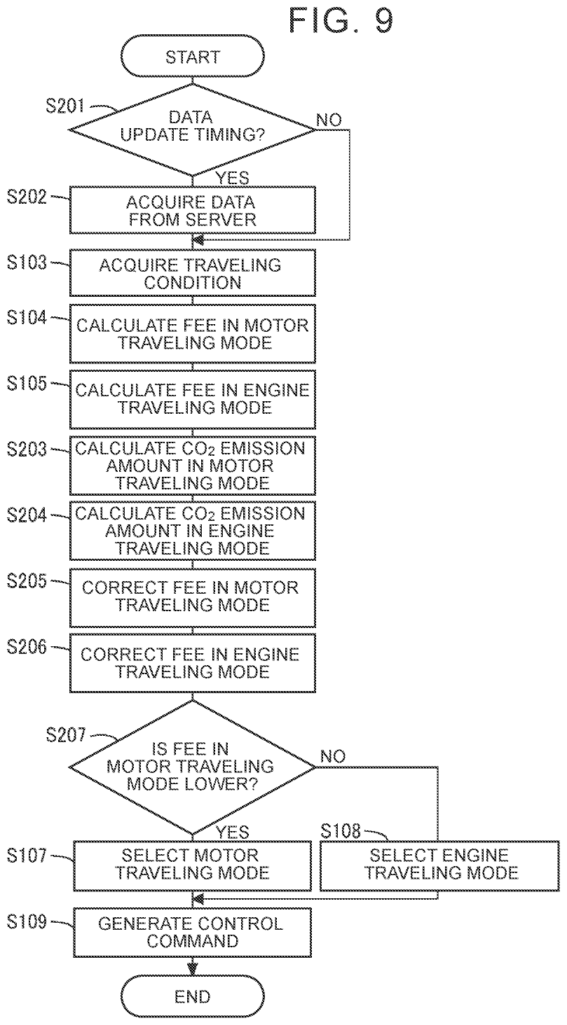

FIG. 8 is a diagram showing an example of a table configuration of information on the CO₂ emission amount stored in the CO₂ emission amount information DB 312. The CO₂ emission amount information DB 312 according to the second embodiment is a database used by the control unit 301 to provide the vehicle 10 with information on the CO₂ emission amount on the WtW basis. The table of the CO₂ emission amount information includes fields for the region, the CO₂ emission amount during fuel consumption, and the CO₂ emission amount during electric power consumption. Since the region field is the same as that in FIG. 3, the description thereof will be omitted. In the field of CO₂ emission amount during fuel consumption, information on the CO₂ emission amount when the fuel of the internal combustion engine 11 is consumed is input. In the field of CO₂ emission amount during fuel consumption, for example, information on the CO₂ emission amount (g/kg) when 1 kg of the fuel is consumed is input. In the field of CO₂ emission amount during electric power consumption, information on the CO₂ emission amount corresponding to the electric energy for charging the battery 16 is input. In the field of CO₂ emission amount during electric power consumption, for example, information on the CO₂ emission amount (g/J) per 1 J of the electric energy is input.

The control unit 301 of the server 30 provides the information on the CO₂ emission amount during fuel consumption and the information on the CO₂ emission amount during electric power consumption in response to a request from the vehicle 10. The control unit 301 acquires the region where the vehicle 10 is located based on the position information received from the vehicle 10. Then, the control unit 301 acquires the information on the CO₂ emission amount during fuel consumption and the information on the CO₂ emission amount during electric power consumption, which correspond to the region, based on the CO₂ emission amount information DB 312, and transmits the information to the vehicle 10.

The control unit 501 calculates the energy consumption when traveling in each traveling mode in the same manner as in the first embodiment, and calculates the CO₂ emission amount based on the energy consumption.

For example, the CO₂ emission amount (g) when the vehicle travels in the motor traveling mode can be calculated by multiplying the consumption energy (J) by the CO₂ emission amount during electric power consumption (g/J). Further, for example, the CO₂ emission amount (g) when the vehicle travels in the engine traveling mode can be calculated by multiplying the value obtained by dividing the consumption energy (J) by the heat generation amount of fuel (J/kg) by the CO₂ emission amount during fuel consumption (g/kg).

The information on the CO₂ emission amount during electric power consumption and the information on the CO₂ emission amount during fuel consumption are acquired from the server 30 and stored in the auxiliary storage unit 53. The above information is acquired from the server 30 by the control unit 501 and updated at predetermined time intervals.

Depending on the amount of electric power stored in the battery 16, the vehicle 10 may not be able to travel in the motor traveling mode. In that case, for example, the vehicle 10 may be caused to travel by using both the internal combustion engine 11 and the electric motor 12 with the engine utilization ratio set to 20%. Further, in the engine traveling mode, the battery 16 may be charged by generating an output higher than the output required for causing the vehicle 10 to travel.

Next, the traveling mode selection process in the vehicle 10 will be described. FIG. 9 is a flowchart of a traveling mode selection process according to the present embodiment. The traveling mode selection process shown in FIG. 9 is executed in the vehicle 10 at predetermined time intervals. It should be noted that the steps in which the same processes as those in the flow shown in FIG. 6 are executed are designated by the same reference signs, and the description thereof will be omitted.

In step S201, the control unit 501 determines whether the data update timing has come. This data is data for calculating the fee when traveling in each traveling mode and the CO₂ emission amount. This data is updated periodically. When the determination result is Yes in step S201, the process proceeds to step S202, and when the determination result is No, the process proceeds to step S103.

In step S202, the control unit 501 acquires data from the server 30. The control unit 501 accesses the server 30 and acquires data for calculating the fee when traveling in each traveling mode and the CO₂ emission amount. At this time, the control unit 501 transmits the position information detected by the GPS receiver 61 to the server 30, and acquires the data according to the region from the server 30. That is, according to the position information received from the vehicle 10, the control unit 301 of the server 30 acquires the information on the fee from the fee information DB 311 and the information on the CO₂ emission amount from the CO₂ emission amount information DB 312, and transmits the information to the vehicle 10.

In the routine shown in FIG. 9, when the process of step S105 is completed, the process proceeds to step S203. In step S203, the control unit 501 calculates the CO₂ emission amount when it is assumed that the vehicle travels in the motor traveling mode under the traveling condition acquired in step S103. The CO₂ emission amount in this case is calculated by the following formula.

CO₂ emission amount (g)=consumption energy (J)×CO₂ emission amount during electric power consumption (g/J)

For the consumption energy and the CO₂ emission amount during electric power consumption, the values received from the server 30 and stored in the auxiliary storage unit 53 are used.

In step S204, the control unit 501 calculates the CO₂ emission amount when it is assumed that the vehicle travels in the engine traveling mode under the traveling condition acquired in step S103. The CO₂ emission amount in this case is calculated by the following formula.

CO₂ emission amount (g)=consumption energy (J)±heat generation amount of fuel (J/kg)×CO₂ emission amount during fuel consumption (g/kg)

For the consumption energy, the heat generation amount of fuel, and the CO₂ emission amount during fuel consumption, the values received from the server 30 and stored in the auxiliary storage unit 53 are used.

In step S205, the control unit 501 corrects the fee in the motor traveling mode calculated in step S104 based on the CO₂ emission amount in the motor traveling mode calculated in step S203. For example, the fee is corrected by multiplying the fee by a coefficient corresponding to the CO₂ emission amount. The coefficient is, for example, a value of one or more and becomes larger as the CO₂ emission amount increases. The relationship between the CO₂ emission amount and the coefficient is stored in the auxiliary storage unit 53 in advance.

In step S206, the control unit 501 corrects the fee in the engine traveling mode calculated in step S105 based on the CO₂ emission amount in the engine traveling mode calculated in step S204. For example, the fee is corrected by multiplying the fee by a coefficient corresponding to the CO₂ emission amount. The coefficient may be the same as the value used in step S205, or may be a different value.

In step S207, the control unit 501 determines whether the fee in the motor traveling mode corrected in step S205 is lower than the fee in the engine traveling mode corrected in step S206. When the determination result is Yes in step S207, the process proceeds to step S107, and when the determination result is No, the process proceeds to step S108.

As described above, according to the present embodiment, a traveling mode in which the CO₂ emission amount is reduced and the fee is lower is selected. In the second embodiment, the CO₂ emission amount has been described as an example, but the embodiment can be similarly applied to the emission amount of other substances. Further, in the second embodiment, the CO₂ emission amount on the WtW basis is calculated, but the CO₂ emission amount may be calculated based on other concepts such as the tank-to-wheel basis as well as the WtW basis. Further, in the present embodiment, the fee is corrected by multiplying the fee by a coefficient corresponding to the CO₂ emission amount, but as an alternative method, the fee may be corrected by adding a value according to the CO₂ emission amount to the fee. Further, in the present embodiment, the traveling mode is selected by comparing the corrected fees, but as an alternative method, for example, when the CO₂ emission amount exceeds the threshold value by switching the traveling mode, the traveling mode may be maintained without being switched. The threshold value is, for example, a value associated with the regulated value of the CO₂ emission amount.

### Other Embodiments

The above-described embodiment is merely an example, and the present disclosure may be appropriately modified and implemented without departing from the scope thereof.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function. For example, the server 30 may have a part of the functions of the vehicle 10. Further, for example, the vehicle 10 may have a part or all of the functions of the server 30.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, HDD, etc.), an optical disc (compact disc read-only memory (CD-ROM), digital versatile disc (DVD), Blu-ray disc, etc.), a read only memory (ROM), a random access memory (RAM), an EPROM, an electrically erasable programmable read only memory (EEPROM), a magnetic card, a flash memory, an optical card, and any type of medium suitable for storing electronic commands.

What is claimed is:

1. An information processing device including a control unit that executes selection of either a mode in which a vehicle travels with an electric motor or a mode in which the vehicle travels with an internal combustion engine, based on information on a fee when the vehicle is caused to travel with the electric motor and information on a fee when the vehicle is caused to travel with the internal combustion engine.

2. The information processing device according to claim 1, wherein the control unit executes
selection of the mode in which the vehicle travels with the electric motor in a case where the fee when the vehicle is caused to travel with the electric motor is lower than the fee when the vehicle is caused to travel with the internal combustion engine, and
selection of the mode in which the vehicle travels with the internal combustion engine in a case where the fee when the vehicle is caused to travel with the electric motor is higher than the fee when the vehicle is caused to travel with the internal combustion engine.

3. The information processing device according to claim 1, wherein the control unit acquires the information on the fee based on a traveling condition of the vehicle.

4. The information processing device according to claim 1, wherein the control unit acquires each of information on the fee when the vehicle travels with the electric motor and information on the fee when the vehicle travels with the internal combustion engine, based on an energy required for the vehicle to travel with the electric motor and an energy required for the vehicle to travel with the internal combustion engine.

5. The information processing device according to claim 4, wherein the control unit acquires each of the information on the fee when the vehicle travels with the electric motor and the information on the fee when the vehicle travels with the internal combustion engine, based on an energy required for the vehicle to travel, an energy for compensating for a decrease in efficiency due to traveling with the electric motor, and an energy for compensating for a decrease in efficiency due to traveling with the internal combustion engine.

6. The information processing device according to claim 1, further comprising a storage unit that stores information on a fee corresponding to a fuel amount of the internal combustion engine and information on a fee corresponding to electric energy when a battery that supplies electric power to the electric motor is charged.

7. The information processing device according to claim 1, wherein the control unit selects either the mode in which the vehicle travels with the electric motor or the mode in which the vehicle travels with the internal combustion engine, based on the information on the fee when the vehicle is caused to travel with the electric motor and information on an environmental load, and the information on the fee when the vehicle is caused to travel with the internal combustion engine and information on an environmental load.

8. The information processing device according to claim 7, wherein the control unit calculates a CO₂ emission amount when the vehicle travels with the electric motor and a CO₂ emission amount when the vehicle travels with the internal combustion engine, as the information on the environmental load.

9. The information processing device according to claim 8, wherein the control unit calculates the CO₂ emission amount on a well-to-wheel basis.

10. The information processing device according to claim 8, further comprising a storage unit that stores information on the CO₂ emission amount corresponding to a fuel amount of the internal combustion engine and information on the CO₂ emission amount corresponding to electric energy when a battery that supplies electric power to the electric motor is charged.

11. The information processing device according to claim 1, further comprising a storage unit that stores, in association with the traveling condition of the vehicle, an energy required for the vehicle to travel, an energy for compensating for a decrease in efficiency due to traveling with the electric motor, and an energy for compensating for a decrease in efficiency due to traveling with the internal combustion engine.

12. An information processing method wherein a computer executes selection of either a mode in which a vehicle travels with an electric motor or a mode in which the vehicle travels with an internal combustion engine, based on information on a fee when the vehicle is caused to travel with the electric motor and information on a fee when the vehicle is caused to travel with the internal combustion engine.

13. The information processing method according to claim 12, wherein the computer executes
selection of the mode in which the vehicle travels with the electric motor in a case where the fee when the vehicle is caused to travel with the electric motor is lower than the fee when the vehicle is caused to travel with the internal combustion engine, and
selection of the mode in which the vehicle travels with the internal combustion engine in a case where the fee when the vehicle is caused to travel with the electric motor is higher than the fee when the vehicle is caused to travel with the internal combustion engine.

14. The information processing method according to claim 12, wherein the computer acquires the information on the fee based on a traveling condition of the vehicle.

15. The information processing method according to claim 12, wherein the computer acquires each of information on the fee when the vehicle travels with the electric motor and information on the fee when the vehicle travels with the internal combustion engine, based on an energy required for the vehicle to travel with the electric motor and an energy required for the vehicle to travel with the internal combustion engine.

16. The information processing method according to claim 15, wherein the computer acquires each of the information on the fee when the vehicle travels with the electric motor and the information on the fee when the vehicle travels with the internal combustion engine, based on an energy required for the vehicle to travel, an energy for compensating for a decrease in efficiency due to traveling with the electric motor, and an energy for compensating for a decrease in efficiency due to traveling with the internal combustion engine.

17. The information processing method according to claim 12, wherein the computer causes a storage unit to store information on a fee corresponding to a fuel amount of the internal combustion engine and information on a fee corresponding to electric energy when a battery that supplies electric power to the electric motor is charged.

18. The information processing method according to claim 12, wherein the computer selects either the mode in which the vehicle travels with the electric motor or the mode in which the vehicle travels with the internal combustion engine, based on the information on the fee when the vehicle is caused to travel with the electric motor and information on an environmental load, the and information on the fee when the vehicle is caused to travel with the internal combustion engine and information on an environmental load.

19. The information processing method according to claim 18, wherein the computer calculates, on a well-to-wheel basis, a CO₂ emission amount when the vehicle travels with the electric motor and a CO₂ emission amount when the vehicle travels with the internal combustion engine, as the information on the environmental load.

20. The information processing method according to claim 19, wherein the computer causes a storage unit to store information on the CO₂ emission amount corresponding to a fuel amount of the internal combustion engine and information on the CO₂ emission amount corresponding to electric energy when a battery that supplies electric power to the electric motor is charged.
